(19) United States
(12) Patent Application Publication
(10) Pub. No.: US 2016/0281947 A1
(43) Pub. Date: Sep. 29, 2016

(54) LENS FOR LED

(71) Applicant: HYUNDAI MOBIS CO., LTD., Seoul (KR)

(72) Inventor: Hyung Rok SHIM, Yongin (KR)

(21) Appl. No.: 15/003,431

(22) Filed: Jan. 21, 2016

(30) Foreign Application Priority Data
Mar. 23, 2015 (KR) 10-2015-0039976

(51) Int. Cl. F21S 8/10; F21V 5/08; G02B 27/00; F21V 5/04

(52) U.S. Cl. CPC F21S 48/1283; F21V 5/04; F21V 5/08; G02B 27/0012

(57) ABSTRACT

Disclosed is a lens for a light emitting diode (LED) of a vehicle. The lens includes an incident surface, into which light of the LED is incident; an emission surface, from which the light of the LED incident through the incident surface is emitted; and a plurality of lateral surfaces which is positioned between the incident surface and the emission surface. Either of the incident surface and the emission surface can includes a Y-axis light blurring region at one side of the incident surface and the emission surface. The Y-axis light blurring region blurs the light from LED in a Y-axis that is perpendicular to the optical axis of the lens.

### CROSS-REFERENCE TO RELATED APPLICATIONS

This application claims priority to and the benefit of Korean Patent Application No. 10-2015-0039976 filed in the Korean Intellectual Property Office on Mar. 23, 2015, the entire contents of which are incorporated herein by reference.

### TECHNICAL FIELD

The present disclosure relates to a lens for a light emitting diode (LED).

### BACKGROUND

In general, a light emitting diode (LED) is an electro-optical converting semiconductor device, which generates minority carriers injected by using a P-N junction structure of a semiconductor and emits light by re-combination of the minority carriers. The LED is smaller than a light source in related technology, has a long lifespan, and directly converts electrical energy into light energy, so that power consumption is minimal and efficiency thereof is excellent.

Recently, there are many cases where the LED is adopted as a light source in order to reduce energy and increase a degree of freedom of a design throughout the whole industry including a lamp for a vehicle, and accordingly, research to effectively and efficiently use the LED has been actively conducted in each industrial field.

### SUMMARY

As one of the methods for efficiently using the LED, a lens for forming an optical image depending on a purpose by collecting or diffusing light of the LED has been developed.

The lens may enable the emitted light of the LED to have a specific pattern, and when a specific light pattern is implemented by using the lens in related technology, a phenomenon, in which aberration is generated and thus light blurs, is generated. The light blurring phenomenon rather acts as a helpful phenomenon in an overlap concept of light, but acts as a disadvantage in implementing a sharp light pattern while collecting light, such as an object of a high beam matrix.

In order to overcome the disadvantage, there may be an optimizing method of decreasing aberration by using several sheets of lens. However, when the several sheets of lenses are used, there are many disadvantages in that cost, an overall size, and weight of the lens are increased.

A matter as important as the light collection in the object of the high beam matrix is to blur light of the LED in a Y-axis direction. However, when the light of the LED blurs in the Y-axis direction, a blurring phenomenon, in which the light of the LED blurs in an X-axis direction, not the Y-axis direction, is generated. The blurring phenomenon causes a failure of the implementation of the object of the high beam matrix for a sharp light pattern.

The present disclosure has been made in an effort to provide a lens for a light emitting diode (LED) capable of implementing an asymmetric and sharp light pattern.

An embodiment of the present invention provides a lens for a light emitting diode (LED), including: an incident surface, into which light of the LED is incident; an emission surface, from which the light of the LED incident through the incident surface is emitted; and a plurality of lateral surfaces which is positioned between the incident surface and the emission surface, in which a Y-axis light blurring region, which enables the light of the LED to be emitted while blurring in a Y-axis direction, is provided at one side of the incident surface and the emission surface.

The plurality of lateral surfaces may include at least four cut surfaces by cutting predetermined portions of the incident surface and the emission surface.

The Y-axis light blurring region may be positioned in a predetermined upper portion based on a center point of each of the incident surface and the emission surface.

The Y-axis light blurring region may be formed by changing a curvature radius, a conic constant, and an aspheric coefficient of the incident surface and the emission surface according to a predetermined algorithm.

The incident surface and the emission surface may have convex shapes in opposite directions facing each other.

The incident surface may have a shape protruding from a center toward the LED in the Y-axis direction.

Another embodiment of the present invention provides a lens for a light emitting diode (LED), including: an incident surface, into which light of the LED is incident; an emission surface, from which the light of the LED incident through the incident surface is emitted; and a lateral surface which is positioned between the incident surface and the emission surface, in which a shield that blocks the light of the LED from being emitted is provided at a predetermined portion of the emission surface, and a Y-axis light blurring region that enables the light of the LED to be emitted while blurring in a Y-axis direction is provided at one side of the incident surface and the emission surface.

The predetermined portion may be formed at each of the upper, lower, left, and right sides of the emission surface.

The Y-axis light blurring region may be positioned in a predetermined upper portion based on a center point of each of the incident surface and the emission surface.

The Y-axis light blurring region may be formed by changing a curvature radius, a conic constant, and an aspheric coefficient of the incident surface and the emission surface according to a predetermined algorithm.

The incident surface and the emission surface may have convex shapes in opposite directions facing each other.

The incident surface may have a shape protruding from a center toward the LED in the Y-axis direction.

According to the lens for the LED according to embodiments of the present invention, when the lens for the LED is applied to a lamp for a vehicle, the lens for the LED may implement a sharp light pattern by inducing light diffusion in the Y-axis direction.

The lens for the LED may enable a user to easily recognize a tree, a person, and the like having a long shape in the Y-axis direction through the implementation of the sharp light pattern.

The lens for the LED may implement an asymmetric and sharp light pattern by changing a shape without needing to use several lenses, thereby decreasing cost compared to related technology.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a light emitting diode (LED) and an aspheric lens applied to a lamp for a vehicle in related technology.

FIG. 2 is a light intensity graph for describing a light pattern of the LED passing through the aspheric lens of FIG. 1.

FIG. 3 is a side view of a lens for an LED according to an embodiment of the present invention.

FIG. 4 is a cross-sectional view for the lens for the LED in a direction X-X′ of FIG. 3.

FIG. 5 is a cross-sectional view for the lens for the LED in a direction Y-Y′ of FIG. 3.

FIGS. 6A and 6B are front views of the lens for the LED according to an embodiment of the present invention.

FIGS. 7A and 7B are light intensity graphs for describing a light pattern of the LED passing through the lens for the LED according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings.

In order to sufficiently understand the present disclosure, the operational advantages of embodiments the present invention, and advantages achieved by carrying out embodiments of the present invention, the accompanying drawings illustrating embodiments of the present invention and the contents described therein need to be referred to.

Hereinafter, the present invention will be described in detail by describing an embodiment of the present invention with reference to the accompanying drawings. However, the present invention may be implemented in various different ways, and is not limited to embodiments to be described below. Further, in order to clearly describe the invention, parts irrelevant to the description are omitted, and the same reference number refers to the same member in the drawing.

Throughout the specification, unless explicitly described to the contrary, the word “comprise” and variations such as “comprises” or “comprising” will be understood to imply the inclusion of stated elements but not the exclusion of any other elements.

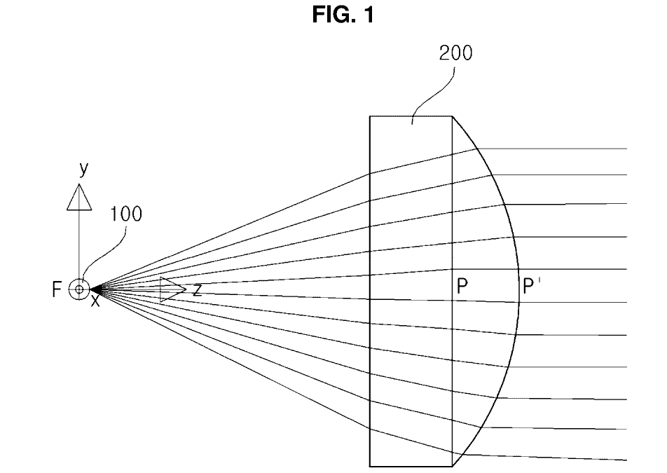

Referring to FIG. 1, it is possible to confirm a light emitting diode (LED) 100 and an aspheric lens 200, which are applied to a lamp for a vehicle and the like in related technology.

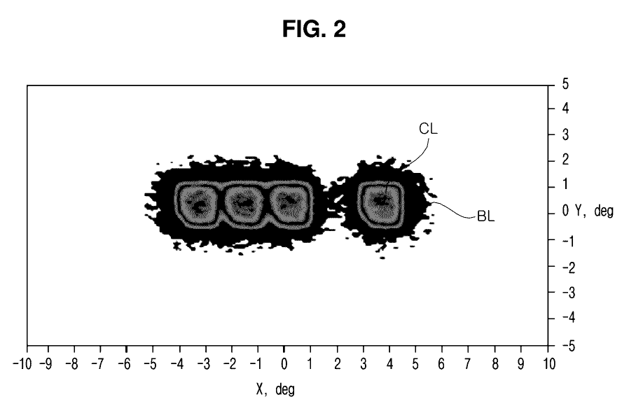

Referring to FIG. 2, it is possible to confirm light CL, which is emitted from the LED 100 and then collected through the aspheric lens 200 of FIG. 1. Here, the LED 100 is an LED chip, in which five LED elements are collected, and one among the LED elements is in a light-out state.

Referring to the collected light CL of FIG. 2, it is possible to confirm blurring light BL due to aberration of the lens in a surrounding area of the light even though the light is in the collected state, and light does not blur in a Y-axis direction.

As described above, the aspheric lens 200 applied to the lamp for the vehicle in related technology cannot implement an asymmetric and sharp light pattern required in an object of a high beam matrix due to a performance limit (surrounding field aberration) and symmetric performance of one sheet of lens.

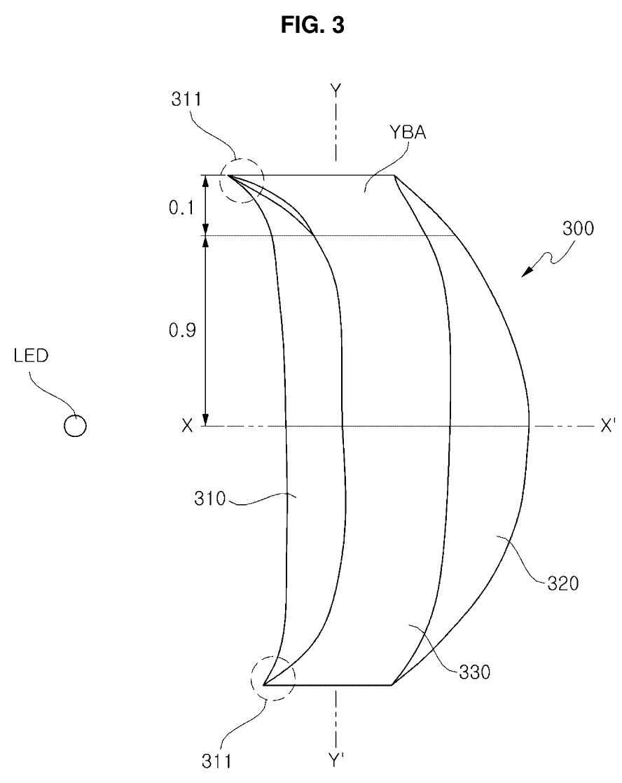

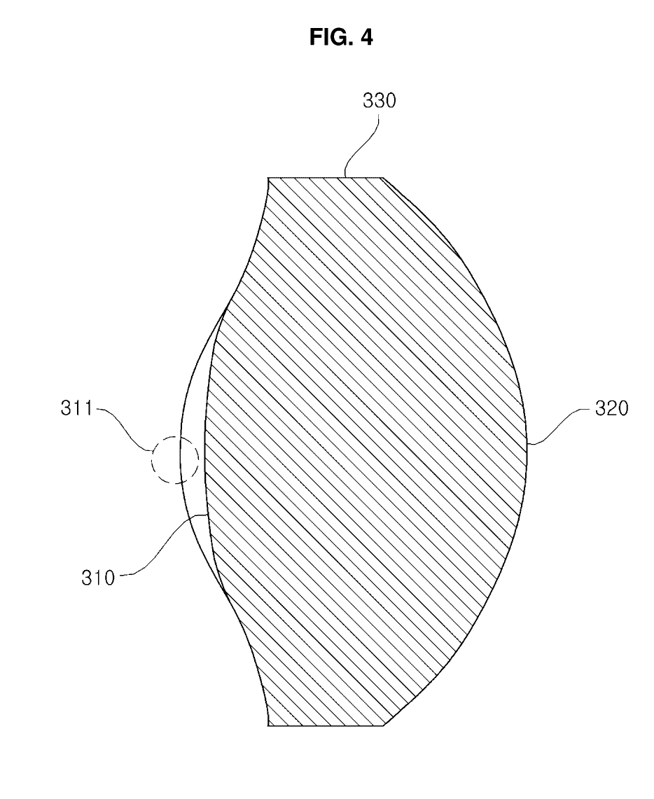

Referring to FIGS. 3 and 4, a lens 300 for an LED according to an embodiment of the present invention is an atypical and aspheric lens capable of implementing an asymmetric and sharp light pattern by using light of the LED when applied to a lamp for a vehicle and the like.

The lens 300 for the LED according to an embodiment of the present invention is formed in a predetermined size. The entire lens 300 for the LED may be formed of a glass material or a polymer-based material. In this case, examples of the polymer-based material include poly carbonate (PC), poly methyl methacrylate (PMMA), and cyclo olefin copolymer (COC), and when the lens 300 for the LED is formed of the polymer-based material, the lens 300 for the LED may be formed of any one of poly carbonate (PC), poly methyl methacrylate (PMMA), and cyclo olefin copolymer (COC).

The lens 300 for the LED formed of the glass material or the polymer-based material includes an incident surface 310, an emission surface 320, and a lateral surface 330, and is formed in an atypical and aspheric shape according to shapes of the incident surface 310, the emission surface 320, and the lateral surface 330 in order to implement an asymmetric and sharp light pattern.

The incident surface 310 is a surface, into which light of the LED is incident. The incident surface 310 may be formed in an atypical shape unlike an incident surface in related technology, in order to implement an asymmetric and sharp light pattern.

The incident surface 310 has a convex and aspheric shape in a direction of the LED, in which light is emitted, and is bent in the direction of the LED toward a Y-axis direction to include a protruding surface 311.

The emission surface 320 is a surface, from which the light of the LED incident through the incident surface 310 is emitted. The emission surface 320 may have a convex and aspheric surface in an opposite direction of the LED.

A Y-axis light blurring area YBA, which enables the light of the LED to be emitted while blurring in the Y-axis direction, may be provided at one side of the incident surface 310 and the emission surface 320.

The Y-axis light blurring area YBA may be positioned in a predetermined upper portion (based on FIG. 3) based on a center point of each of the incident surface 310 and the emission surface 320.

Here, when it is assumed that a ratio of a total length from the center point of each of the incident surface 310 and the emission surface 320 to an edge in an upper outer circumference direction (based on FIG. 3) is 1, the Y-axis light blurring area YBA may be positioned in a portion, in which the ratio of the length is 0.9 to 1.

Accordingly, the predetermined portion of each of the incident surface 310 and the emission surface 320, in which the Y-axis light blurring area YBA is positioned, is formed in an asymmetric shape with a predetermined portion of each of the incident surface 310 and the emission surface 320 positioned at an opposite side based on the X-axis direction.

The Y-axis light blurring area YBA may blur the light of the LED in the Y-axis direction, and thus the light of the LED is implemented in a sharp light pattern in the Y-axis direction.

The Y-axis light blurring area YBA may be formed in the incident surface 310 and the emission surface 320 according to an algorithm set based on an XY polynomial expression generally used in designing a lens. A variable of the XY polynomial expression includes a curvature radius (commonly expressed by “R”), a conic constant (commonly expressed by “K”), and an aspheric coefficient of the lens 300 for the LED, and the predetermined algorithm may generate the Y-axis light blurring area YBA in the incident surface 310 and the emission surface 320 by adjusting the curvature radius, the conic constant, and the aspheric coefficient.

In general, the conic constant k is a factor determining a shape of the lens, and when the conic constant k is 0, the lens has a circular shape, when the conic constant k is −1, the lens has a parabolic shape, when the conic constant k is −1<k<0, the lens has an elliptical shape, and when the conic constant k is k<−1, the lens has a hyperbolic shape.

The curvature radius, the conic constant, and the aspheric coefficient of the Y-axis light blurring area YBA have different values from those of a curvature radius, a conic constant, and an aspheric coefficient of a symmetric area at the opposite side based on the X-axis direction by the algorithm.

The lateral surface 330 is positioned between the incident surface 310 and the emission surface 320. A width of the lateral surface 330 may be appropriately set.

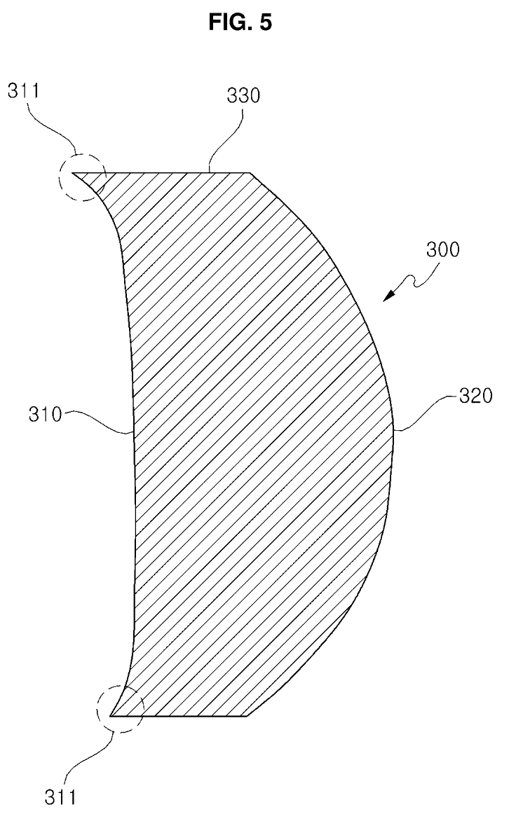

FIG. 4 is a cross-sectional view for the lens for the LED in a direction X-X′ of FIG. 3. FIG. 5 is a cross-sectional view for the lens for the LED in a direction Y-Y′ of FIG. 3.

Referring to FIGS. 4 and 5, the shapes of the incident surface 310 and the emission surface 320 can be confirmed in more detail.

The incident surface 310 cross-sectioned in the direction X-X′ has a convex and aspheric shape in the direction of the LED, and the protruding surface 311, which is not cross-sectioned, has a sharp shape in the direction of the LED.

The incident surface 310 cross-sectioned in the direction Y-Y′ has a roughly flat shape, but is bent from a center to an outer side in the direction of the LED. Accordingly, the protruding surface 311 is formed at the edge of the incident surface 310 in the Y-axis direction.

The emission surfaces 320 cross-sectioned in the direction X-X′ and the direction Y-Y′ have almost similar shapes, which represents that the emission surface 320 has a rotation symmetric aspheric shape.

However, the Y-axis light blurring area YBA is positioned in the upper portion of the lens 300 for the LED according to an embodiment of the present invention, and there is no Y-axis light blurring area YBA in the lower portion of the lens 300 for the LED, so that it is obvious that the lens 300 for the LED has a rotation asymmetric aspheric shape.

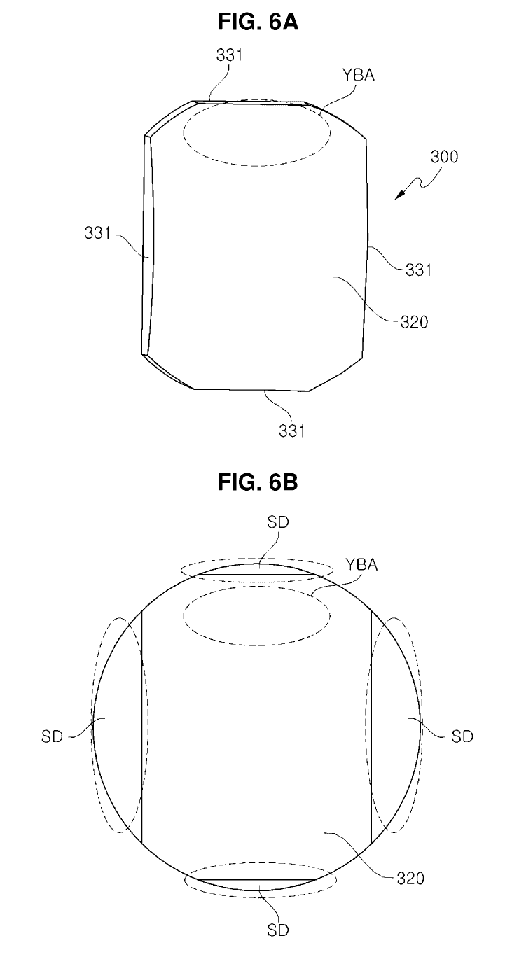

Referring to FIGS. 6A and 6B, FIG. 6A illustrates a front surface of a lens 300 for an LED provided with a plurality of lateral surfaces 330 according to a first embodiment of the present invention, and FIG. 6B illustrates a front surface of a lens 300 for an LED provided with a shield SD according to a second embodiment of the present invention.

In FIG. 6A, the lens 300 for the LED according to the first embodiment of the present invention may include a lateral surface 330 including at least four cut surfaces 331.

The cut surfaces 331 may be formed at an upper side, a lower side, a left side, and a right side based on the lens 300 for the LED of FIG. 6A, respectively. The cut surface 331 may be formed by cutting a predetermined portion of each of an incident surface 310 and an emission surface 320. Here, the cut portions are portions generating aberration of the lens in the incident surface 310 and the emission surface 320, in order to inhibit generation of the aberration of the lens, the cut surface 331 is formed by cutting the predetermined portion of each of the incident surface 310 and the emission surface 320.

When light emitted from one point forms an image by a lens or a reflector, the light is not collected at one point, but forms a distorted image, and the distorted image in this case is caused by the aberration of the lens.

In FIG. 6B, the lens 300 for the LED according to the second embodiment of the present invention may include the shield SD at a predetermined portion of an emission surface 320. The emission surface 320 according to the second embodiment of the present invention may also be formed by being surrounded with the shield SD which is a material for blocking light of the LED from being projected, without cutting a predetermined portion generating aberration of the lens. The emission surfaces 320 at an upper side, a lower side, a left side, and a right side based on the lens 300 for the LED of FIG. 6B are formed by being surrounded with the shield SD.

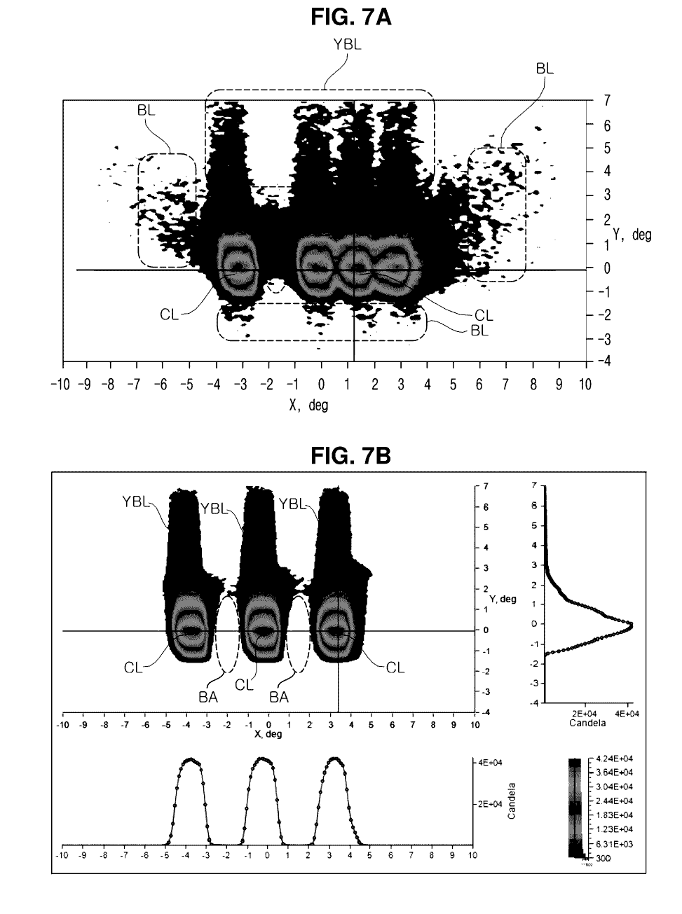

Referring to FIGS. 7A and 7B, it is possible to confirm an LED light pattern generated by passing through the lens 300 for the LED according to an embodiment of the present invention.

FIG. 7A illustrates an LED light pattern generated by passing through the lens 300 for the LED (the lens illustrated in FIGS. 3 to 5) in a state where the predetermined portion of the emission surface 320 generating aberration of the lens is not cut or is not blocked with the shield SD.

FIG. 7B illustrates an LED light pattern generated by passing through the lens 300 for the LED (the lens illustrated in FIG. 6) in a state where the predetermined portion of the emission surface 320 generating aberration of the lens is cut is blocked with the shield SD.

Referring to FIG. 7A, it is possible to confirm the LED light pattern, in which the collected light CL, the light YBL blurring in the Y-axis direction, and the light BL blurring due to the aberration of the lens are mixed.

This implements a sharp light pattern in the Y-axis direction through the Y-axis light blurring area YBA, but it is shown that light blurs up to a dark area BA required when one LED is turned off.

Referring to FIG. 7B, it is possible to confirm the asymmetric and sharp light pattern including the collected light CL and the light YBL blurring in the Y-axis direction.

This represents that the emission of the light is fundamentally blocked by cutting the portion generating the aberration of the lens or surrounding the portion generating the aberration of the lens with the shield, except for the portion generating the light YBL blurring in the Y-axis direction.

Here, in order to implement the dark area BA of 300 cd or lower in the portion when the LED is turned off, a change in light quantity of 60,000 cd or more in the unit of 1 degree is required. To this end, the predetermined portion of the emission surface 320 may be cut or blocked with the shield until a change in light quantity of 60,000 cd/deg (gradient) is implemented.

The light BL blurring in the X-axis direction of FIG. 7A may be removed by cutting the predetermined left and right portions (based on FIG. 6) of the lens 300 for the LED or surrounding the predetermined left and right portions (based on FIG. 6) of the lens 300 for the LED with the shield.

The light BL blurring in a Y-axis down direction of FIG. 7A may be removed by cutting the predetermined upper and lower portions (based on FIG. 6) of the lens 300 for the LED or surrounding the predetermined upper and lower portions (based on FIG. 6) of the lens 300 for the LED with the shield.

In the lens 300 for the LED according to an embodiment of the present invention, light passing through the predetermined portion of the emission surface 320 cut or surrounded with the shield disappears, so that overall light efficiency is decreased, but light reaching a desired region is rarely decreased, so that it is possible to implement a desired light pattern without a considerable decrease in efficiency of a region for actual use.

The lens 300 for the LED according to an embodiment of the present invention may implement an asymmetric and sharp beam pattern with one lens, unlike the method in related technology, which uses several sheets of lenses formed of different materials.

As described above, embodiments of the present invention have been described and illustrated in the drawings and the specification. The embodiments were chosen and described in order to explain certain principles of the invention and their practical application, to thereby enable others skilled in the art to make and utilize various embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lens for a light emitting diode (LED), comprising:
an incident surface configured to receive light beams from the LED;
an emission surface configured to emit at least part of the light beams received at the incident surface; and
a plurality of lateral surfaces interposed between the incident surface and emission surface,
wherein a Y-axis light blurring region configured to blur at least part of the light beams in a Y-axis direction perpendicular to an optical axis of the lens is provided on the incident surface or the emission surface.

2. The lens of claim 1, wherein the plurality of lateral surfaces includes at least four cut surfaces by cutting predetermined portions of the incident surface and the emission surface.

3. The lens of claim 1, wherein the Y-axis light blurring region is positioned in a predetermined upper portion based on a center point of each of the incident surface and the emission surface.

4. The lens of claim 3, wherein the Y-axis light blurring region has a different curvature radius, a different conic constant, and a different aspheric coefficient from the incident surface and the emission surface.

5. The lens of claim 1, wherein the incident surface and the emission surface have convex shapes in opposite directions facing each other.

6. The lens of claim 5, wherein the incident surface has a shape protruding from a center toward the LED in the Y-axis direction.

7. A lens for a light emitting diode (LED), comprising:
an incident surface configured to receive light beams from the LED;
an emission surface configured to emit at least part of the light beams received at the incident surface; and
a lateral surface interposed between the incident surface and the emission surface, a shield abutting a predetermined portion of the emission surface and configured to block at least part of the light beams, and
wherein a Y-axis light blurring region configured to blur at least part of the light beams in a Y-axis direction perpendicular to an optical axis of the lens is provided on the incident surface or the emission surface.

8. The lens of claim 7, wherein the predetermined portion is formed at each of the upper, lower, left, and right sides of the emission surface.

9. The lens of claim 7, wherein the Y-axis light blurring region is positioned in a predetermined upper portion based on a center point of each of the incident surface and the emission surface.

10. The lens of claim 9, wherein the Y-axis light blurring region has a different curvature radius, a different conic constant, and a different aspheric coefficient from the incident surface and the emission surface.

11. The lens of claim 7, wherein the incident surface and the emission surface have convex shapes in opposite directions facing each other.

12. The lens of claim 11, wherein the incident surface has a shape protruding from a center toward the LED in the Y-axis direction.
